(19) United States
(12) Patent Application Publication
(10) Pub. No.: US 2013/0282595 A1
(43) Pub. Date: Oct. 24, 2013

(54) METHOD AND APPARATUS FOR OPTIMIZING WEB AND MOBILE SELF-SERVE APPS

(71) Applicant: 24/7 CUSTOMER, INC., Campbell, CA (US)

(72) Inventors: Ravi VIJAYARAGHAVAN, Bangalore (IN); R. Mathangi SRI, Bangalore (IN)

(73) Assignee: 24/7 Customer, Inc., Campbell, CA (US)

(21) Appl. No.: 13/867,746

(22) Filed: Apr. 22, 2013

Related U.S. Application Data
(60) Provisional application No. 61/637,700, filed on Apr. 24, 2012.

(51) Int. Cl. G06Q 30/00

(52) U.S. Cl. CPC G06Q 30/016
USPC 705/304

(57) ABSTRACT

An embodiment of the invention takes advantage of the fact that the intuitive power of a self-serve app lies in constant learning. The app must quickly evolve to predict customer needs and provide the right content to the right customer. In an embodiment, Web and mobile self-serve apps are optimized by leveraging the chat data of drop-off customers from each screen of the app. In an embodiment, self-serve drop-off data is combined with chat data, the customer's identity data and Web log data to provide a powerful source for driving the targeting and content optimization of the app.

### CROSS REFERENCE TO RELATED APPLICATIONS

This application claims priority to U.S. provisional patent application Ser. No. 61/637,700, filed Apr. 24, 2012, which application is incorporated herein in its entirety by this reference thereto.

### BACKGROUND OF THE INVENTION

1. Technical Field

The invention relates to the customer experience when using a Web or mobile self-serve app. More particularly, the invention relates to a method and apparatus for optimizing Web and mobile self-serve apps to increase issue resolutions and purchases and to provide an improved customer experience.

2. Description of the Background Art

Apps

Application software is all of the computer software that causes a computer to perform useful tasks beyond the running of the computer itself. A specific instance of such software is called a software application, application, or app.

The term app is used to contrast such software with system software, which manages and integrates a computer's capabilities, but does not directly perform tasks that benefit the user. The system software serves the application which, in turn, serves the user.

Examples include enterprise software, accounting software, office suites, graphics software and media players. Many application programs deal principally with documents. Applications may be bundled with the computer and its system software, or may be published separately.

Application software applies the power of a particular computing platform or system software to a particular purpose.

A mobile application, or mobile app, is a software application designed to run on smartphones, tablet computers, and other mobile devices. Mobile apps are usually available through application distribution platforms, which are typically operated by the owner of the mobile operating system, such as the Apple App Store, Google Play, Windows Phone Store, and BlackBerry App World. Some apps are free, while others must be bought. Usually, apps are downloaded from the platform to a target device, such as an iPhone, BlackBerry, Android phone, or Windows Phone, but sometimes they can be downloaded to laptops or desktops.

Mobile apps were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, and ticket purchases. The explosion in number and variety of apps made discovery a challenge, which in turn led to the creation of a wide range of review, recommendation, and curation sources, including blogs, magazines, and dedicated online app-discovery services.

The popularity of mobile applications has continued to rise, as their usage has become increasingly prevalent among mobile phone users. A May 2012 comScore study reported that during the previous quarter, more mobile subscribers used apps than browsed the Web on their devices: 51.1% vs. 49.8%, respectively.

Self-Serve Software

Self-serve software is a subset within the knowledge management software category and which contains a range of software that specializes in the way information, process rules, and logic are collected, framed within an organized taxonomy, and accessed through decision support interviews. Self-serve software allows people to secure answers to their inquiries and/or needs through an automated interview fashion instead of traditional search approaches.

Self-serve software allows authors, typically subject-matter experts, to automate the deployment of, the timeliness of, and compliance around a variety of processes with which they are involved in communicating without having to address physically the questions, needs, and solicitations of end-users who are inquiring about the particular process being automated.

Self-serve software primarily addresses closed-loop inquiries, whereby the author emulates a variety of known (finite) questions and related (known) responses on hand or required steps that must be addressed to derive and deliver a final answer or directive. Often the author using such software codifies such known processes and steps then generates (publishes) end-user facing applications which can encompass a variety of code bases and platforms.

Self-serve software is sometimes referred to decision support software and even expert systems. It is typically categorized as a subtopic within the knowledge management software category. Self-serve software allows individuals and companies alike to tailor and address customer support, technical support, and employee support inquiries and needs in an on-demand fashion, where the person with a question (need) can interface with the author's generated application via a computer, a handheld device, a kiosk, register, or other machine type to secure their answers as if they were directly interacting (talking to) the author.

Some self-serve software is able to handle automatic execution of processes. An approval process can also be added to the workflow. For instance, to give managers the possibility to keep track of the cost related to the ordered services by employees.

Self-serve software has been offered as an app, for example as a Help feature in a banking, subscription management, or other app. However, such self-serve apps are subject to frequent customer drop-off, i.e. where a customer exits the app due to frustration with the app's ability to service the customer's needs. It would be advantageous to provide a self-serve app that predicts customer needs and provides the right content to the right customer.

### SUMMARY OF THE INVENTION

An embodiment of the invention provides a technique that takes advantage of the fact that the intuitive power of a self-serve app lies in constant learning. The app must quickly evolve to predict customer needs and provide the right content to the right customer. In an embodiment, Web and mobile self-serve apps are optimized by leveraging the chat data of drop-off customers from each screen of the app. In an embodiment, drop-off chat data is combined with the customer's identity data and Web log data to provide a powerful source for driving the targeting and content optimization of the app.

### BRIEF DESCRIPTION OF THE DRAWINGS

FIG. 1 is a flow diagram that shows a technique for improving app performance by using chat and Web mining for learning and optimization according to the invention;

FIG. 2 is a block schematic diagram showing a system for using chat to optimize apps according to the invention; and

FIG. 3 is a block schematic diagram that depicts a machine in the exemplary form of a computer system within which a set of instructions for causing the machine to perform any of the herein disclosed methodologies may be executed.

### DETAILED DESCRIPTION OF THE INVENTION

An embodiment of the invention provides a technique that takes advantage of the fact that the intuitive power of a self-serve app lies in constant learning. The app must quickly evolve to predict customer needs and provide the right content to the right customer. In an embodiment, Web and mobile self-serve apps are optimized by leveraging the chat data of drop-off customers from each screen of the app. In an embodiment, drop-off chat data is combined with the customer's identity data and Web log data to provide a powerful source for driving the targeting and content optimization of the app.

Consider the first screen of an app which typically concerns the issue and/or intent of a customer who is looking for help and/or information. If the screen predicts the right issue, the customer moves on; otherwise, the customer falls out, i.e. the customer leave the app either in frustration and/or to seek assistance to another, less efficient channel, such as through a call center. Mining chats that pop up at this stage of the app flow helps a customer service organization to understand the top reason for drop-off in the first screen. In an embodiment of the invention, this chat-based knowledge is combined with the customer's Web journey and identity to improve the intent models used to target customers. Similarly, mining the drop-off chats that occur after the resolution screen help the customer service organization to understand the different resolutions provided to the customer. This knowledge can be fed back into the app to improve its content.

Online chat may refer to any kind of communication over the Internet, that offers a real-time direct transmission of text-based messages from sender to receiver, hence the delay for visual access to the sent message does not hamper the flow of communications in any of the directions. Online chat may address point-to-point communications, as well as multicast communications from one sender to many receivers and voice and video chat, or may be a feature of a Web conferencing service.

Online chat in a less stringent definition may be primarily any direct text-based or video-based (webcams), one-on-one chat or one-to-many group chat (formally also known as synchronous conferencing), using tools such as instant messengers, Internet Relay Chat (IRC), talkers and possibly MUDs. The expression online chat comes from the word chat which means informal conversation. Online chat includes Web-based apps that allow communication, often directly addressed, but anonymous between users in a multi-user environment. Web conferencing is a more specific online service, that is often sold as a service, hosted on a Web server controlled by the vendor. An embodiment of the invention concerns such chat in the context of customer engagement, such as sales and/or service.

For purposes of the discussion herein, text mining, sometimes alternately referred to as text data mining, roughly equivalent to text analytics, refers to the process of deriving high-quality information from text, such as chat text. High-quality information is typically derived through the devising of patterns and trends through means such as statistical pattern learning. Text mining usually involves the process of structuring the input text, usually parsing, along with the addition of some derived linguistic features and the removal of others, and subsequent insertion into a database; deriving patterns within the structured data; and finally evaluation and interpretation of the output. High quality in text mining usually refers to some combination of relevance, novelty, and interestingness. Typical text mining tasks include text categorization, text clustering, concept and/or entity extraction, production of granular taxonomies, sentiment analysis, document summarization, and entity relation modeling, i.e. learning relations between named entities.

Text analysis involves information retrieval, lexical analysis to study word frequency distributions; pattern recognition; tagging and/or annotation; information extraction; data mining techniques, including link and association analysis; visualization; and predictive analytics. The overarching goal is, essentially, to turn text into data for analysis, via application of natural language processing (NLP) and analytical methods. An embodiment of the invention uses such text analysis and text mining techniques to understand and learn from the causes of customer chat drop-off.

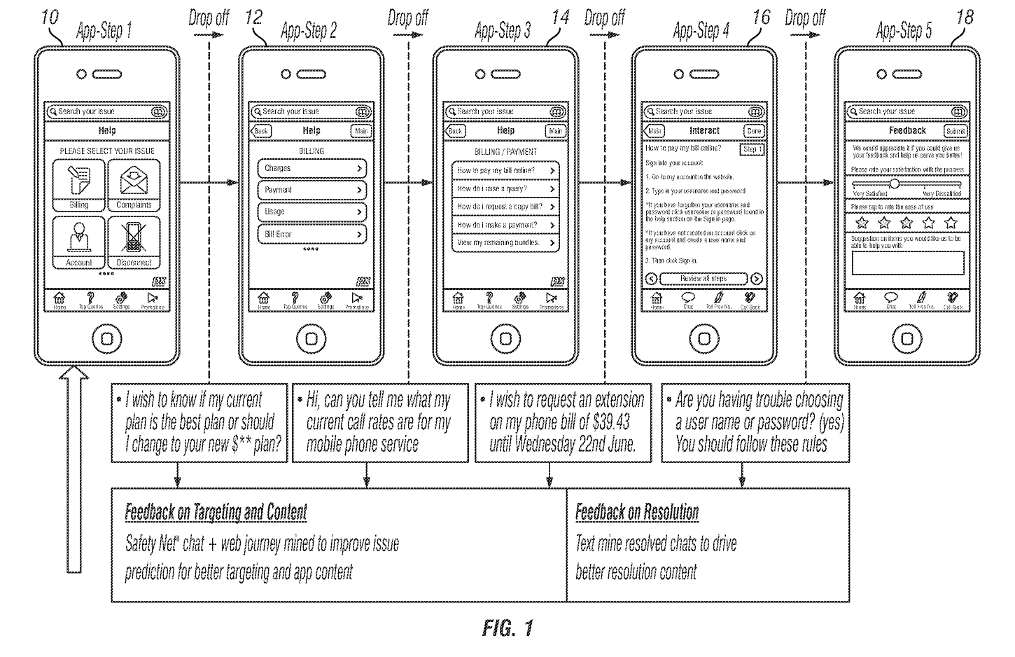

FIG. 1 is a flow diagram that shows a technique for improving app performance by using chat and Web mining for learning and optimization according to the invention. At Step 1 (10) the customer is asked to select an issue. For example, a Help screen in a cell phone subscription service (Safety Net) is presented to the customer that asks the customer to select among Billing, Complaints, Account, Disconnect.

If this screen does not address the customer issue, then the customer drops off. In this example, the customer asks: “I wish to know if my current plan is the best plan of should I change to you new $** plan?” According to an embodiment of the invention, this produces feedback on targeting and content. The system data mines the customer chat and Web journey to improve issue prediction for better targeting and app content.

Typically, the Web journey reflects the customer's intent. Once the customer has expressed his intent in the chat, with this new intent stated in the chat as the response variable, it is possible to train the model to learn about the customer's intent on corresponding Web journeys. The new model is overlaid on an existing model and the weights there between are adjusted to improve the resulting model's accuracy. For example, in this case because the customer is asking about changing a plan, the journey or the pages that could have been significant predictors include, for example, landing on the plan page, etc.

For purposes of the invention herein, the Web journey concerns the customer engagement cycle, i.e. the stages that customers travel through as they interact with a particular brand, product, and/or service. This customer engagement cycle, or customer journey, has been described using a myriad of terms but most often consists of five different stages: awareness, consideration, inquiry, purchase and retention. The Web journey is that portion of the customer engagement cycle that takes place on-line.

If the Step 1 screen does address the customer's issue, then the customer progresses to Step 2 (12). In this case, the customer selected Billing in Step 1 and is now at the Billing screen in the Help app. The Billing screen produces categories on Charges, Payment, Usage, and Bill Error.

In an embodiment of the invention, the customer interacts with the self-serve app and, in case he does not find an answer, he drops off from his journey and engages in chat and may raise a query e.g. “I wish to know if my . . . .” Thus, if the customer does not find the answer he wants, he drops off. The customer is then offered a chat and in the chat he asks “Hi, please provide billing error assistance.” Because there was no answer in the self-serve app he had dropped off and gone on to chat.

In this example, in the self-serve app the customer wished to know his call rates. Because there is no answer for this question at Step 2, the customer drops off and engages in a chat and asks: “Hi, can you tell me what my current call rates are for my mobile phone service?”. According to an embodiment of the invention, this produces feedback on targeting and content. The system data mines the customer chat and Web journey to improve issue prediction for better targeting and app content.

If the customer progresses to Step 3 (14), then the Billing/Payment screen of the Help app displays such topics as: How to pay my bill online? How do I raise a query? How do I request a copy bill? How do I make a payment? View my remaining bundles.

In this example, the customer asks: “I wish to request an extension on my phone bill of $39.43 until Wednesday 22^{nd} June.” Because there is no answer for this question at Step 3, the customer had dropped off of the self-serve app. That is, there was no answer in the self-serve app and customer dropped off. Again, the drop off from the self-serve app occurs first, and then the chat query is asked. According to an embodiment of the invention, this produces feedback on targeting and content. The system data mines the customer chat and Web journey to improve issue prediction for better targeting and app content.

If the customer progresses to Step 4 (16), then the customer is at the Interact screen of the app. In this example, the customer is given instructions for paying a bill online.

The customer is not successful and drops off. During a chat session following such drop off, the customer is asked by the agent: “Are you having trouble choosing a user name or password?” The customer answers (yes). The agent advises the customer: “You should follow these rules.”

According to an embodiment of the invention, this produces feedback on resolution. The system text mines resolved chats to drive better resolution content. For example, if the user has forgotten his user name or password and the link provided in self-serve app is not working, the user drops off to chat to seek additional resolution. Thereafter, the user gets the desired resolution. In this case, an alternate link might be provided to the customer to allow him reset the password. In the future, this resolution step can also be part of the self-serve app.

In an embodiment, this is done by:
1. Identifying drop off chats at a given step;
2. Identifying whether it was a drop off from an issue or a resolution step; and
3. If it is a resolution, text mining agent lines to summarize the additional resolution provided.

This aspect of the invention is part of the self-serve widget console.

If the customer progresses to step 5 (18), the customer can provide feedback. For example, the system can collect feedback, such as ease of use and relevance. The system can also tailor the feedback depending on the amount of time that the customer spent or the stage at which he dropped off. Thus, feedback can then be used to address the pain points in the flow.

As can be seen, at each step of the customer's interaction with the app, a customer drop-off provides an opportunity to improve the app.

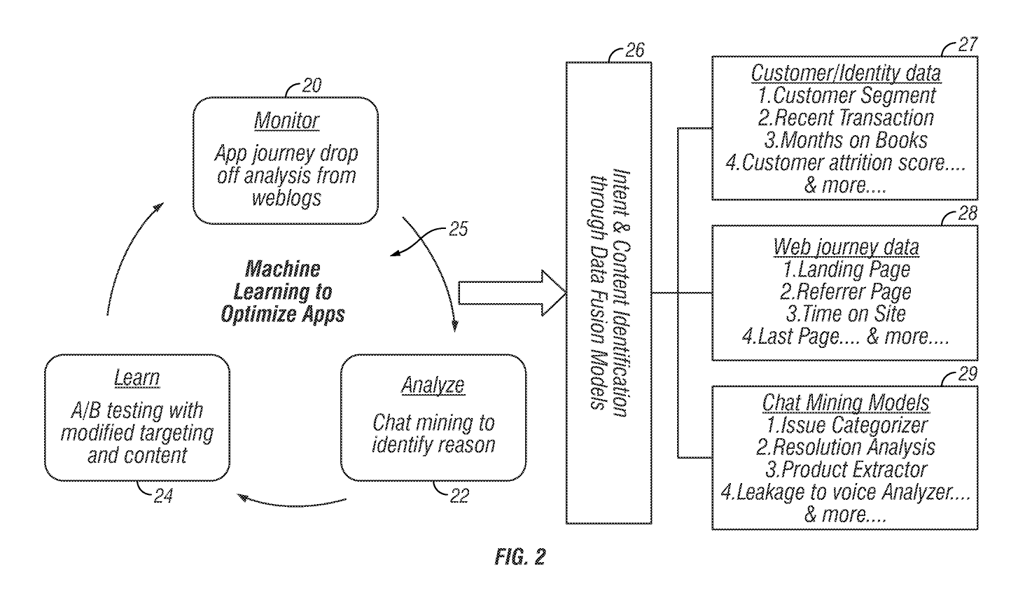

FIG. 2 is a block schematic diagram showing a system for using chat to optimize apps according to the invention. In FIG. 2, machine learning is used to optimize apps 25. The system monitors app journey drop-off analysis from Web logs 20. Webservers register a log for every single activity that happens on the website. Such activities could be, and are not restricted to, landing on a page, navigating to another page, time of navigation, clicks and the type of page loaded, mouse overs, etc. Chat mining is used to identify the reason for the drop-off 22 using a variety of techniques. Once the customer has dropped off the Web journey he engages in a chat and asks queries. Text mining of these chats is used to learn the customer's intent. This is performed using a variety of techniques, both supervised and unsupervised. In supervised learning, the system trains the models on annotated data. Some of the supervised techniques that can be used are a query categorization approach, machine learning techniques, such as naïve Bayes, SVM, neural networks, etc. In an embodiment, before machine learning techniques are applied, text processing is performed using NLP techniques.

In an embodiment, the system learns from this analysis by performing A/B testing with modified targeting and content 24. In Web development and marketing, A/B testing or split testing is an experimental approach to Web design, especially user experience design, which aims to identify changes to Web pages that increase or maximize an outcome of interest, e.g. click-through rate for a banner advertisement.

As the name implies, two versions (A and B) are compared, which are identical except for one variation that might impact a user's behavior. Version A might be the currently used version, while Version B is modified in some respect. For instance, on an e-commerce Web site the purchase funnel is typically a good candidate for A/B testing, as even marginal improvements in drop-off rates can represent a significant gain in sales. Significant improvements can be seen through testing elements, such as copy text, layouts, images and colors. Multivariate testing or bucket testing is similar to A/B testing, but tests more than two different versions at the same time. An embodiment of the invention uses A/B testing, based upon chat mined customer-drop data, to improve and optimize app design.

In the embodiment of FIG. 2, machine learning is a continuous process that dynamically adapts as it learns from user interaction with an app. The model auto corrects itself based on the difference between predicted and actual intent of the customer. Once the difference is identified, based on intent extracted from chat, the original model is readjusted. Hence, this is self-learning and the model becomes robust over time and with more data. The machine learning output is used for intent and content identification through data fusion models 26. In an embodiment, data fusion is the process of integration of multiple data and knowledge representing the same real-world object into a consistent, accurate, and useful representation. Fusion of the data from two or more sources, for example dimension #1 & #2, can yield a classifier superior to any classifiers based on dimension #1 or dimension #2 alone. Data fusion processes are often categorized as low, intermediate, or high, depending on the processing stage at which fusion takes place. Low level data fusion combines several sources of raw data to produce new raw data. The expectation is that fused data is more informative and synthetic than the original inputs.

The output of the data fusion models depends upon data from such sources as customer and/or identity data 27, such as the customer segment, recent transactions, months the customer transaction is carried on a company's books, customer attrition score, etc.; Web journey data 28, such as the customer's landing page, referred page, time on a particular Web site, last page visited, etc.; and chat mining models 29, such as issue categorizer models, resolution analysis, product extractor models, leakage to voice analysis, etc.

Chats are categorized using a variety of text mining models, such as query categorization, product extraction, Info/Action, stage wise, etc. With the categorized chats as response variables and the journey as the predictor variables, the system builds multinomial models to predict customer intent. Some of the techniques used in this are Naive-Bayes, SVM, multinomial logistic regression, etc.

Computer Implementation

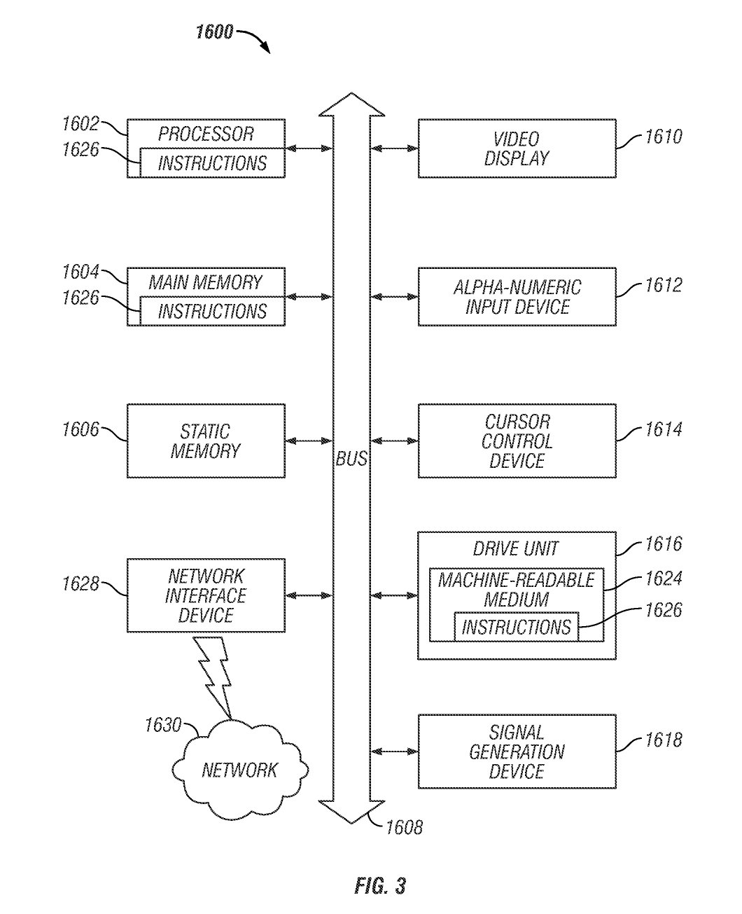

FIG. 3 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for optimizing any of Web and self-serve apps, comprising:
a processor collecting and analyzing chat data of drop-off customers from each screen of a Web or self-serve app;
said processor combining said drop-off chat data with Web log data; and
said processor applying said combined drop-off chat data, and Web log data to optimize customer issue prediction and said app content.

2. The method of claim 1, further comprising:
said processor also combining said drop-off chat data with a customer's identity data.

3. The method of claim 2, further comprising:
said processor applying said combined drop-off chat data, customer identity data, and Web log data to optimize customer issue prediction and said app content.

4. The method of claim 1, wherein said processor text mines resolved chats to optimize resolution content.

5. The method of claim 1, wherein said processor receives customer feedback for app optimization.

6. The method of claim 1, said processor executing machine learning to optimize apps.

7. The method of claim 1, said processor monitoring app journey drop-off analysis from Web logs.

8. The method of claim 7, wherein said processor text mines chats to identify a reason for said drop-off.

9. The method of claim 7, said processor learning from said analysis by performing A/B testing with modified targeting and content.

10. The method of claim 7, wherein said machine learning is a continuous process that dynamically adapts as it learns from user interaction with an app.

11. The method of claim 7, wherein said machine learning effects intent and content identification through application of one or more data fusion models.

12. The method of claim 11, said one or more data fusion models using data from one or more sources comprising any of customer and/or identity data, comprising any of customer segment, recent transactions, months a customer transaction is carried on a company's books, and customer attrition score; Web journey data, comprising ay of said customer's landing page, referred page, time on a particular Web site, and last page visited; and chat mining models, comprising any of issue categorizer models, resolution analysis, product extractor models, and leakage to voice analysis.

13. An apparatus for optimizing any of Web and self-serve apps, comprising:
a processor comprising a module for collecting and analyzing chat data of drop-off customers from each screen of a Web or self-serve app;
said processor comprising a module for combining said chat data of drop-off customers with a customer's identity data and Web log data; and
said processor comprising a module for applying said combined drop-off chat data, customer identity data, and Web log data to optimize customer issue prediction and said app content.

14. The apparatus of claim 13, said processor comprising a module for learning from said analysis by performing A/B testing with modified targeting and content.

15. The apparatus of claim 13, said processor comprising a module for machine learning, wherein said machine learning module effects intent and content identification through application of one or more data fusion models.

16. The apparatus of claim 15, said one or more data fusion models using data from one or more sources comprising any of customer and/or identity data, comprising any of customer segment, recent transactions, months a customer transaction is carried on a company's books, and customer attrition score; Web journey data, comprising ay of said customer's landing page, referred page, time on a particular Web site, and last page visited; and chat mining models, comprising any of issue categorizer models, resolution analysis, product extractor models, and leakage to voice analysis.
